(19) United States
(12) Patent Application Publication
(10) Pub. No.: US 2011/0158444 A1
(43) Pub. Date: Jun. 30, 2011

(54) HEARING INSTRUMENT AND METHOD FOR PROVIDING HEARING ASSISTANCE TO A USER

(75) Inventor: Bernd Waldmann, Maur (CH)

(73) Assignee: PHONAK AG, Staefa (CH)

(21) Appl. No.: 13/061,193

(22) PCT Filed: Aug. 29, 2008
(86) PCT No.: PCT/EP08/07093

§ 371 Date: Feb. 28, 2011

(51) Int. Cl. H04R 25/00

(52) U.S. Cl. 381/326

(57) ABSTRACT

A hearing instrument having an audio signal processing unit (16) for processing audio signals and a device (20) for vibrating at least one of the a user's eyeballs (22) in the audible frequency range according to the processed audio signals in order to stimulate the user's hearing sense.

### BACKGROUND OF THE INVENTION

1. Field of the Invention

The present invention relates to a hearing instrument comprising an audio signal processing unit for processing audio signals and means for stimulating the user's hearing sense according to the processed audio signals. The invention also relates to a method for providing hearing assistance to a user.

2. Description of Related Art

Acoustic stimuli usually reach the inner ear via the external ear canal and middle ear ossicles, which is the pathway into which conventional electro-acoustic hearing aids and implantable electro-mechanical middle ear hearing devices inject amplified signals for treatment of sensorineural or conductive hearing loss. The cochlea can also be stimulated via an alternative pathway called bone conduction, wherein a vibration of the entire skull creates an auditory sensation. Conventional explanations for this phenomenon (Stenfelt, S. “Overview and recent advances in bone conduction physiology” in: Huber, A., Eiber, A. (eds.) “Middle Ear Mechanics in Research and Otology”, Singapore 2007) involve (a) compression of the intracochlear fluid caused by the skull vibration, (b) the inertia of the ossicles causing their movement relative to the skull, which in turn stimulates the inner ear, or (c) movement of the walls of the external ear canal, which creates airborne sound in the external ear canal.

More recently, experiments indicate that the vibration of the cerebrospinal fluid (CSF) itself, which is connected to the intracochlear fluid, is sufficient to create an auditory sensation (Lupin, A. J. “A new concept implantable hearing aid” in: “2007 Conference on Implantable Auditory Prostheses”). This theory is corroborated by the observation that a vibration imparted to the eyeball, which is also surrounded by fluid connected to the CSF and therefore to the intracochlear fluid, can create an auditory sensation.

U.S. Pat. No. 4,498,461 relates to an example of a bone-anchored hearing aid (BAHA), which comprises an osseo-integrated, percutaneous bone screw attached to the skull and a vibration transducer coupled to the skull via the bone screw.

U.S. Pat. No. 7,033,313 B2 describes an implantable hearing system attached to the skull, which is designed to vibrate the dura mater and thereby the CSF.

U.S. Pat. No. 5,251,627 describes a non-invasive measurement of eyeball pressure using vibrations in a frequency range of 20 to 5000 Hz. This concept is further elaborated in U.S. Pat. No. 5,865,742 by describing the use of an ultrasonic beam to create a change of shape in the eyeball in order to measure the eyeball pressure.

German Patent Application DE 103 39 027 A1 relates to a visual hearing aid which comprises a display for presenting optical patterns corresponding to audio signals to the eyes of the user in order to use the visual sense of the user for sound perception. The display may be integrated into a glasses-like device.

The well-known BAHA systems, while providing adequate amplification for mild to moderate hearing losses, contain a percutaneous element, with potential infection risk, and involve the necessity for a surgical procedure to place the bone screw. This problem is even more severe for fully or partially implantable electro-mechanical hearing aids. Non-invasive bone conduction hearing aids require a transducer pressed against the skull, potentially causing skin irritation.

### SUMMARY OF THE INVENTION

It is an object of the invention to provide for a hearing instrument for stimulating the inner ear, which bypasses the middle ear and the ossicles, while avoiding the problems of current bone conduction hearing aids, namely invasive designs or pressure against the skin. It is also an object of the invention to provide for method for providing hearing assistance to a user.

According to the invention these objects are achieved by a hearing instrument and by a method as described herein.

The invention is beneficial in that, by providing means for vibrating at least one of the user's eyeballs in the audible frequency range according to the processed audio signals, the user's hearing sense can be stimulated in a manner which bypasses the middle ear and the ossicles, while nevertheless an invasive design or pressure against the user's skin is avoided.

These and further objects, features and advantages of the present invention will become apparent from the following description when taken in connection with the accompanying drawings which, for purposes of illustration only, show several embodiments in accordance with the present invention.

### BRIEF DESCRIPTION OF THE DRAWINGS

FIG. 1 is a block diagram of a first embodiment of a hearing instrument according to the invention;

FIG. 2 is view like FIG. 1, wherein an alternative embodiment of the invention is shown;

FIG. 3 is a view like FIG. 1, wherein another alternative embodiment of the invention is shown; and

FIG. 4 is a schematic side view of an embodiment of a hearing instrument according to the invention.

### DETAILED DESCRIPTION OF THE INVENTION

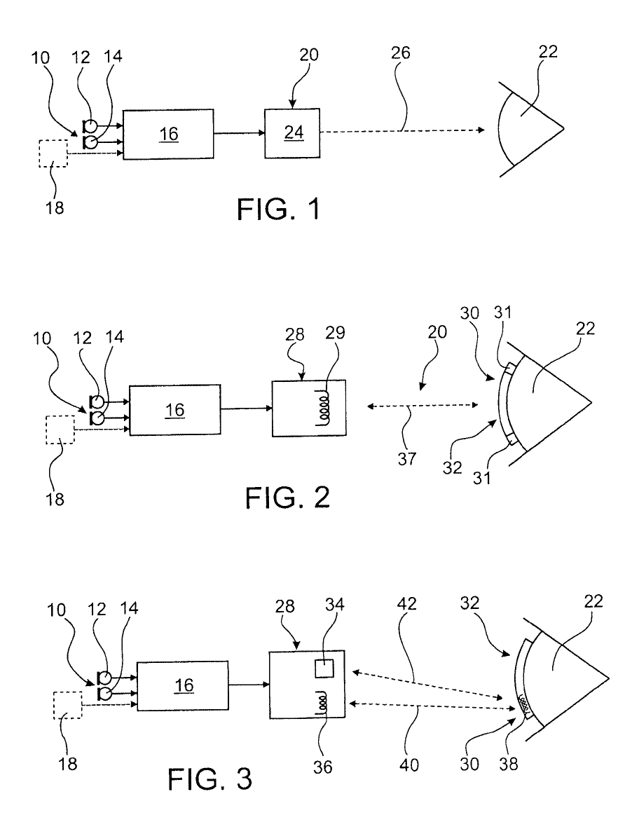

FIG. 1 is a block diagram of a first embodiment of a hearing instrument according to the invention, which comprises a microphone arrangement 10, which preferably consists of a plurality of spaced-apart microphones 12, 14 for capturing audio signals from ambient sound, which signals are provided to an audio signal unit 16. Alternatively or in addition to the microphone arrangement 10 the audio signal processing unit 16 may comprise an input for audio signals from an external device 18, such as an FM (frequency modulation) receiver for receiving audio signals from a remote microphone (not shown) via an FM link, or an external audio source, such as a TV device, a telephone device or a music player.

The audio signal processing unit 16 is adapted to transform the audio signals received from the microphone arrangement 10 and/or the external device 18 into processed audio signals, which are supplied to an output transducer 20. The audio signal processing unit 16 comprises the necessary amplifiers and preferably has the capability of selecting specific audio signal processing programs depending on the present auditory scene detected by the audio signal processing unit 16 from the received audio signals. In particular, the audio signal processing unit 16 preferably is capable of performing different types of acoustic beam forming based on the signals from the microphones 12, 14 of the microphone arrangement 10. Such type of audio signal processing is well-known for conventional electro-acoustic hearing instruments. The plurality of microphones 12, 14 may be arranged in a manner so as to form a broadfire or endfire array, as known in the art, in order to create a highly directional sensitivity pattern which serves to attenuate or eliminate unwanted noise sources from directions other than the direction of a desired sound source, which is typically a communication partner.

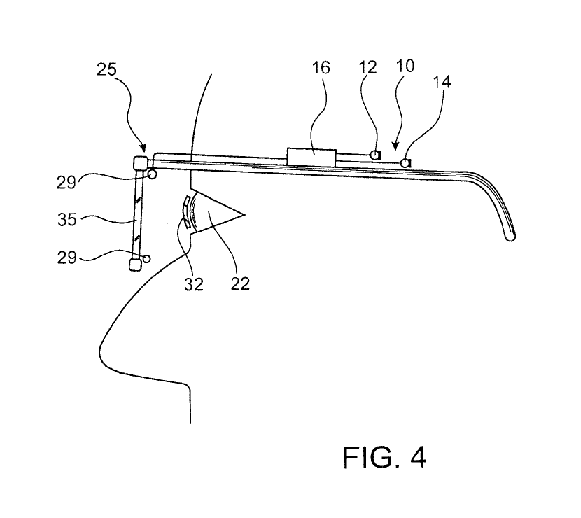

The output transducer 20 is adapted to vibrate at least one of the user's eyeballs 22 in the audible frequency range according to the processed audio-signals provided by the audio signal processing unit 16 in order to stimulate the user's hearing sense via the fluid surrounded by the eyeball 22, which fluid is connected to the CSF and therefore to the intracochlear fluid. The output transducer 20 thus acts as a vibrating means which is adapted to apply forces onto at least one of the eyeballs 20 in a contactless manner. Preferably, the output transducer 20 is supported at least in part by a holding unit 25 which is to be worn at the user's head and which preferably is designed like a spectacle frame, see FIG. 4. In particular, the holding unit 25 is designed in such a manner that the output transducer 20 is located close to the eyeballs 22. The holding unit 25 also serves to support the microphone arrangement 10 and the audio signal processing unit 16.

According to the embodiment shown in FIG. 1, the output transducer 20 comprises an ultra-sound generator 24 for creating an ultrasonic beam 26 directed at the eyeball 22, which beam is modulated by the processed audio signals supplied by the audio signal processing unit 16 in order to provide for a vibration of the eyeball 22 according to the processed audio signals. Preferably, the ultrasonic beam is be amplitude-modulated by the processed audio signals.

The embodiment of FIG. 2 is an example of electromagnetic, i.e., inductive, actuation of the eyeball 22. In this case, the output transducer 20 comprises a first element 28 fixed at the holding unit 25 and a second element 30 in contact with the eyeball 22, with the first element 28 and the second element 30 being adapted to create an electromagnetic force between the first element 28 and the second element 30 in order to move the second element 30 relative to the first element 28 according to the processed audio signals. Preferably, the second element 30 forms part of a contact lens 32. Preferably, the first element 28 and the second element 30 are adapted to create an electromagnetic force 37 between the first element 28 and the second element 30 in such a manner that it is (usually amplitude-) modulated according to the processed audio signals.

In the example of FIG. 2, the first element 28 comprises an electromagnetic coil 29, and the second element 30 comprises a permanent magnet 31. By generating an alternating current according to the processed audio signals through the coil 29 the magnet 31, and hence the contact lens 32, is moved relative to the coil 29, thereby vibrating the eyeball 22. Preferably, the coil 29 is integrated in the holding unit 25 in a manner so as to surround one of the lenses 35. The magnet 31 is integrated within the contact lens 32.

According to the embodiment shown in FIG. 3, the first element 28 comprises a permanent magnet 34 and a transmission coil 36, and the second element 30 comprises an electromagnetic coil 38 integrated within the contact lens 32. The transmitter coil 36 serves to power the electro-magnetic coil 38 via an RF (radio frequency)-link 40 modulated according to the processed audio signals. The alternating current induced in the coil 38 creates an electro-magnetic force 42 between the coil 38 and the permanent magnet 34, which serves to move the coil 38 relative to the magnet 34, thereby vibrating the eyeball 22. The transmission coil 36 may be integrated in the holding unit 25 in a manner so as to surround one of the lenses 35.

Usually, the connection between the output transducer 20 and the audio signal processing unit 16 will be wired. However, it is also conceivable to use a wireless connection. Also, the connection between the microphone arrangement 10 and the audio signal processing unit 16 may be wired or wireless.

The ultrasound generator 24 of FIG. 1 may be integrated within the frame surrounding the lenses 35.

In general, a single output transducer 20 may be provided for one of the eyeballs 22, or a separate output transducer 20 may be provided for each of the eyeballs 22.

While various embodiments in accordance with the present invention have been shown and described, it is understood that the invention is not limited thereto, and is susceptible to numerous changes and modifications as known to those skilled in the art. Therefore, this invention is not limited to the details shown and described herein, and includes all such changes and modifications as encompassed by the scope of the appended claims.

1-20. (canceled)

21. A hearing instrument, comprising
an audio signal processing unit for processing audio signals; and
means for vibrating at least one eyeball of the user in an audible frequency range according to processed audio signals in order to stimulate a user's hearing sense.

22. The hearing instrument of claim 21, wherein the vibrating means are adapted to apply forces onto the at least one eyeball in a contactless manner.

23. The hearing instrument of claim 21, wherein the vibrating means are supported at least in part by a holding unit that is wearable on a user's head.

24. The hearing instrument of claim 23, wherein the holding unit is designed in such a manner that the vibrating means are located close to the at least one eyeball.

25. The hearing instrument of claim 24, wherein the holding unit is configure in the manner of a spectacle frame.

26. The hearing instrument of claim 25, wherein the vibrating means comprises a first element fixed at the holding unit and second element in contact with the at least one eyeballs, with the first and the second element being adapted to create an electromagnetic force between the first and the second element in order to move the second element relative to the first element according to the processed audio signals.

27. The hearing instrument of claim 26, wherein the second element is part of a contact lens.

28. The hearing instrument of claim 26, wherein the first element and the second element are adapted to create an electromagnetic force between the first element and the second element which is modulated according to the processed audio signals.

29. The hearing instrument of claim 26, wherein the first element is comprises a electromagnetic coil and the second element comprises a permanent magnet.

30. The hearing instrument of claim 29, wherein the electromagnetic coil is integrated in the holding unit in a manner so as to surround a lens of the spectacle frame.

31. The hearing instrument of claim 26, wherein the first element comprises a permanent magnet and the second element comprises an electromagnetic coil.

32. The hearing instrument of claim 31, wherein a transmitter coil located at the holding unit is provided for powering the electromagnetic coil via a radio frequency link modulated according the processed audio signals.

33. The hearing instrument of claim 23, wherein the vibrating means comprises an ultrasound generator for creating an ultrasonic beam directed at the eyeball(s), which beam is modulated by the processed audio signals.

34. The hearing instrument of claim 23, wherein the audio signal processing unit is supported by the holding unit.

35. The hearing instrument of claim 23, wherein the hearing instrument comprises a microphone arrangement for supplying audio signals to the audio signal processing unit.

36. The hearing instrument of claim 35, wherein the microphone arrangement is supported by the holding unit.

37. The hearing instrument of claim 36, wherein the microphone arrangement comprises a plurality of spaced apart microphones for imparting beam forming capability to the hearing instrument.

38. The hearing instrument of claim 37, wherein the microphones of the microphone arrangement are configured to form a broadfire array.

39. The hearing instrument of claim 37, wherein the microphones of the microphone arrangement are configured to form an endfire array.

40. A method for providing hearing assistance to a user, comprising:
generating audio signals;
processing said audio signals; and
vibrating at least one eyeball of the user in an audible frequency range according to the processed audio signals in order to stimulate a user's hearing sense.
